(19) United States
(12) Patent Application Publication
(10) Pub. No.: US 2008/0126674 A1
(43) Pub. Date: May 29, 2008

(54) Portable storage device and method for improving data access speed

(76) Inventor: Xiaohua Cheng, Shenzhen (CN)

Correspondence Address: FOLEY AND LARDNER LLP;SUITE 500, 3000 K STREET NW, WASHINGTON, DC, 20007, US

(21) Appl. No.: 11/520,390

(22) Filed: Sep. 13, 2006

(51) Int. Cl. G06F 12/00; G06F 12/02

(52) U.S. Cl. 711/103; 711/115; 711/E12.008; 711/E12.001

(57) ABSTRACT

The present invention provides a portable storage device and method capable of improving data access speed. Said portable storage device is capable of data transmission with a host computer system, said portable storage device includes: a control module capable of data transmission with a host computer through a communication protocol, a storage module capable of data storage. The characteristics of said portable storage device include: said storage module includes one or multiple basic storage modules; said control module can conduct data access operation with the basic storage module(s). The method for improving data transmission speed is to transmit data from the host computer system to said one or multiple basic storage modules alternately using data packet as unit, the speed of data reading and writing to said storage module is greatly improved.

### BACKGROUND OF THE INVENTION

1. Field of the Invention

The present invention relates to data storage control technology, particularly relates to a portable storage device and a method for the improvement of data access speed.

2. Background of the Invention

As personal computer has become ever popular, various digital products are involved deeply with people's daily life and work. Processing and transporting large quantity of data has become a problem needing immediate solution. As a result, various portable data storage devices (also called removable storage device or external storage device) have emerged. Among them, semiconductor data storage device becomes more and more widely used because of its small size, large capacity, high speed, ease of transportation, performance stability, resistance to physical destruction, and etc.

Presently, a semiconductor data storage device consists of a control module and a storage media module. A host computer system reads and writes data to the storage media through a control module. The control module can communicate with the host computer by data transport protocol, wherein the communication includes sending commands and transmitting data. The control module then performs data operation to the storage media after receiving commands and data. Because of the inherent reading and writing characteristics of the storage media, data transmission between the host computer and the control module is much faster than data reading/writing speed of the control module to the storage media. Therefore speed of data reading and writing operation from the control module to the storage media becomes bottleneck of the entire data transmission process.

For example, portable storage device using USB for data transmission and Flash Memory as storage media are now widely used; after the introduction of USB2.0, data transmission speed between the host computer and the storage media can reach 480 Mbps. However, because of the limitation of the data reading/writing speed of the flash memory storage media, the maximum speed of data access to an 8 bit flash memory storage media is limited to 160 bps. Furthermore, the above mentioned portable storage device's control module uses single-channel control method to control the flash memory storage media, and can read and write to only one flash memory storage media chip each time. For a single-chip 8 bit flash storage media, the highest experimental data transmission speed is 80 bps for reading and 64 bps for writing; for a single-chip 16 bit flash storage media, the highest experimental data transmission speed is 160 bps for reading and 128 bps for writing. Apparently, under this control model, the control module's data access to flash storage media is much slower than data transmission between the host computer and the control module. Such inefficient utilization of data transmission speed between host computer and control module in turn limits the data access speed between host computer and storage media.

In view of the deficiency of the available technology, there is a great need for a device and method for improving data access speed.

### SUMMARY OF THE INVENTION

In view of the deficiency of the available technology, an object of this invention is to provide a portable storage device and a method capable of improving data access speed.

The object of the present invention—to provide a portable storage device capable of improving data access speed—is accomplished by the following technical scheme:

Said portable storage device is capable of data transmission with a host computer system, said portable storage device includes: a control module capable of data transmission with a host computer through a communication protocol, a storage module capable of data storage. The characteristics of said portable storage device include: said storage module includes one or multiple basic storage modules, said control module can conduct data access operation with the basic storage module(s).

Said basic storage module in said portable storage device capable of improving data access speed includes a single storage media unit or multiple storage media units.

Said control module in said portable storage device capable of improving data access speed is connected to said basic storage module(s) through control bus, address bus, data bus, said data bus includes but not limited to 8-bit, 16-bit and/or 32-bit data bus.

The present invention is also to provide a method capable of improving data access speed. The object is accomplished by the following technical scheme:

Said data access speed improving method applies to improve data access speed between a host computer and a portable storage device. Said portable storage device includes: a control module capable of data transmission with the host computer through a communication protocol, a storage module for data storage. Said method includes:
1) providing one or multiple basic storage modules for data storage in said storage module;
2) providing one or multiple data channels between said control module and corresponding said basic storage module(s).
3) performing reading and writing operation on the data from the host computer using data packet as unit, in a time slicing manner through corresponding said data channel(s).

Said data packet's size in said data access speed improving method includes but not limited to 512 bytes, 528 bytes, 2048 bytes and 2112 bytes.

Said data channel in said control module in said data access speed improving method can be connected with said basic storage module(s) through data bus of 8-bit, 16-bit and/or 32-bit.

Said data channel in said data access speed improving method may be a 16-bit data bus connecting to two 8-bit data bus which are then respectively connected to the basic storage modules.

Said data channel in said data access speed improving method may be a 32-bit data bus connecting to two 16-bit data bus which are then respectively connected to the basic storage modules.

Said data channel in said data access speed improving method may be a 32-bit data bus connecting to four 8-bit data bus which are then respectively connected to the basic storage modules.

Said portable storage device includes storage card in a variety of digital equipments or other types of storage equipment, such as Flash Memory Disk, Portable Hard Drive, CF Card (Compact Flash Card), MS Card (Memory Stick Card), mini MS, PCMCIA Card, SMC (Smart Media Card), MMC (Multi Media Card), mini MMC, SD Card (Secure Digital Card), mini SD, xD, MD and etc.

In the present invention, the storage module of the portable storage device has one or multiple basic storage modules, and each basic storage module includes one or multiple storage media units. It is capable of data reading and writing operation on data from the host computer using data packet as unit, in a time slicing manner, therefore greatly improves the reading and writing speed of the storage media.

### BRIEF DESCRIPTION OF THE DRAWINGS

FIG. 1 is a block diagram of the structure of the portable storage device connecting to the host computer for the improvement of data access speed in the first preferred embodiment of the present invention.

FIG. 2 is a block diagram of the structure of the portable storage device connecting to the host computer for the improvement of data access speed in the second preferred embodiment of the present invention.

FIG. 3 is a block diagram of the structure of the portable storage device connecting to the host computer for the improvement of data access speed in the third preferred embodiment of the present invention.

FIG. 4 is a block diagram of the structure of the portable storage device connecting to the host computer for the improvement of data access speed in the fourth preferred embodiment of the present invention.

### DETAILED DESCRIPTION OF THE INVENTION

Following is the description of preferred embodiments of the present invention, which description should be taken in conjunction with the accompanying drawings.

### 1. Embodiment One

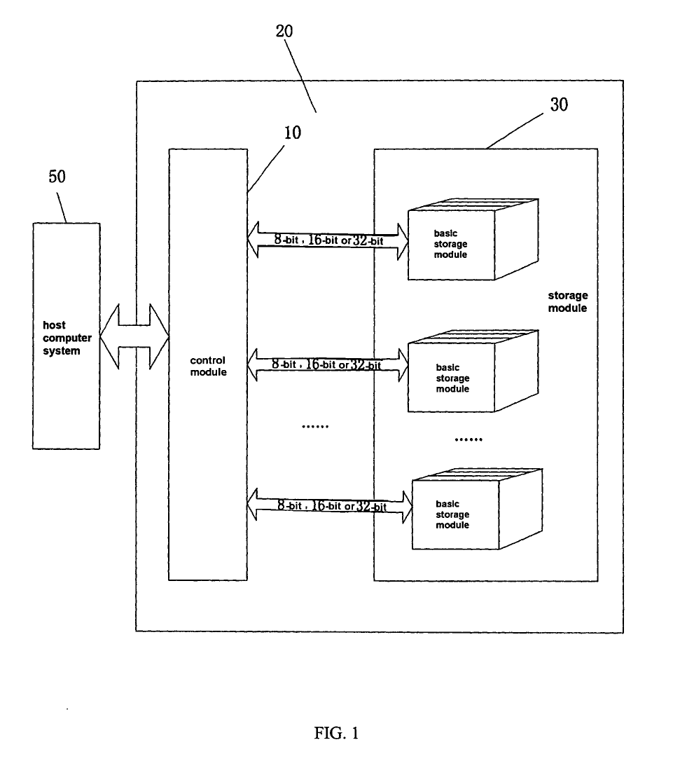

In the first preferred embodiment (taking FIG. 1 in conjunction), the portable storage device 20 for improving data access speed includes a control module 10 and a storage module 30.

Said control module 10 is connected to the host computer 50. Said control module 10 can transmit data with the host computer 50 through communication protocol. Said communication protocol includes but not limited to: USB Protocol, Zigbee Protocol, IEEE1394 Protocol, Laya Protocol, Serial ATA Protocol, IDE Protocol, SCSI Protocol, HiperLAN Protocol, IrDA Infra Protocol, HomeRF Protocol, IEEE802.11x, IEEE802.11a, 802.11b, 802.11d, 802.11.g. 802.15, 802.16, 802.3 Protocol, RS232 Protocol, RS485 Protocol, USB_OTG Protocol, UWB Protocol, GPIO Protocol, UART Protocol, CF Protocol, SM Protocol, MMC Protocol, SD Protocol, MS Protocol, MD Protocol, X-D Protocol, PCMCIA Protocol, GSM, GPRS, CDMA, 2.5G and/or 3G Protocol, and etc.

Said control module 10 can conduct data reading and writing operation to storage module 30, accomplishing data access between the host computer 50 and the storage module 30.

Said storage module 30 includes N number of basic storage modules, wherein N is a natural number. Said every basic storage module includes one or multiple storage media. Increasing storage volume can be accomplished through increasing the number of storage media.

Said storage media in said basic storage module is selected from but not limited to following storage media: Flash Memory, SDRAM, DRAM, EPPROM, Static Random Access Memory (SRAM), Ferroelectric Random Access Memory (FRAM), Magnetoresistive Random Access Memory (MRAM), super high density memory chip MILLIEPE, and etc.

Said control module 10 is connected to basic storage module(s) in said storage module 30 through a bus. Said bus includes control/status bus, address bus, data bus, in which data bus is selected from but not limited to 8-bit, 16-bit, and/or 32 bit data bus.

Said control module 10 can conduct data reading and writing operation to storage module 30 by the following two methods.

METHOD 1: after said control module 10 receives the first data packet from the host computer 50, it writes the first data packet to the first basic storage module through said 8-bit, 16-bit or 32-bit data bus; after said control module 10 receives the second data packet from the host computer 50, it writes the second data packet to the second basic storage module. In the same manner, after said control module 10 receives the number N data package, it writes the number N data packet to the number N basic storage module.

When said control module 10 receives the number N+1 data package, it returns to the first basic storage module, that is to store the number N+1 data packet to the first data storage module.

Said control module 10 repeats the process of “writing the first data packet to the number N data packet” to writes the number N+1 to N+N data packet to the basic storage modules in said storage module 30. The cycle is repeated until all the data packets are written into said storage module 30.

Size of said data packet can be defined. The size can be but not limited to 512 bytes, 528 bytes, 2048 bytes, 2112 bytes, and etc.

According to the above described process, said control module can recycle operating said 1st to Nth basic storage module in a time slicing manner. Because data transmission between the host computer 50 and said control module 10 is much faster than data transmission between said control module 10 and a single basic data storage module, said control module 10 may contain a buffer of a number of data packet; when the data transmission speed between the host computer 50 and said control module 10 equals to N times of data transmission speed between said control module 10 and a single basic storage module (as above discussed, there are N basic storage modules in said storage module 30), said basic storage module will not be leave idle await data packet Therefore the data transmission speed between the host computer 50 and said control module 10 matches the data transmission speed between said control module 10 and said storage module 30, highest efficiency is accomplished.

METHOD 2 is to divide each data packet into several parts then to operate multiple basic storage modules simultaneously.

### 2. Embodiment Two

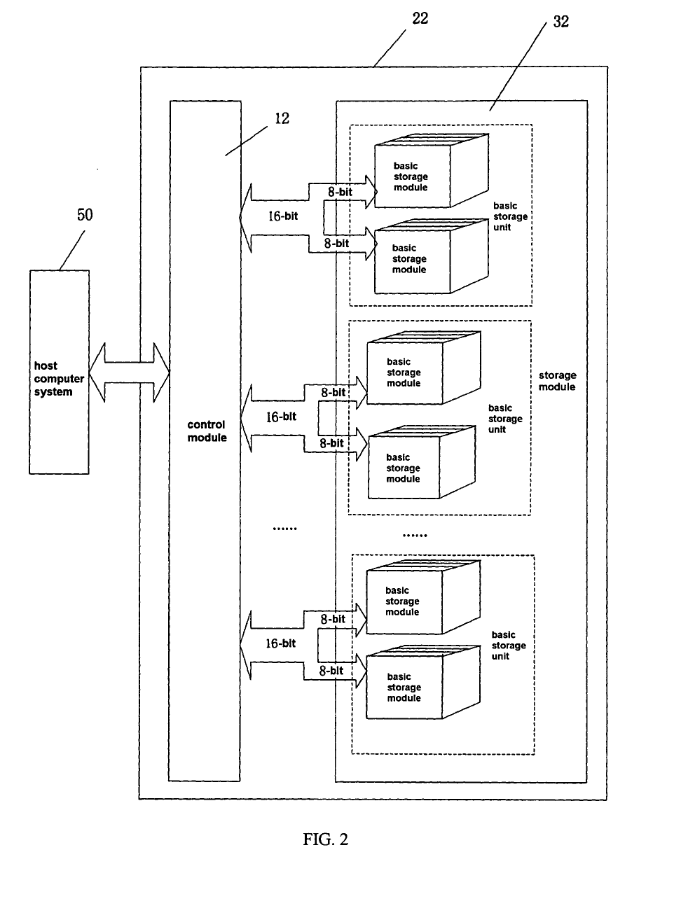

In the second preferred embodiment (taking FIG. 2 in conjunction), a portable storage device 22 capable of improving data access speed includes a control module 12 and a storage module 32. Said control module 12 is connected to the host computer 50; said control module 12 can transmit data with the host computer 50 through various communication protocol; said communication protocol includes but not limited to USB Protocol, Zigbee Protocol, IEEE1394 Protocol, Laya Protocol, Serial ATA Protocol, IDE Protocol, SCSI Protocol, HiperLAN Protocol, IrDA Infra Protocol, HomeRF Protocol, IEEE802.11x, IEEE802.11a, 802.11b, 802.11d, 802.11.g. 802.15, 802.16, 802.3 Protocol, RS232 Protocol, RS485 Protocol, USB_OTG Protocol, UWB Protocol, GPIO Protocol, UART Protocol, CF Protocol, SM Protocol, MMC Protocol, SD Protocol, MS Protocol, MD Protocol, X-D Protocol, PCMCIA Protocol, GSM, GPRS, CDMA, 2.5G and/or 3G Protocol, and etc.

Said storage module 32 includes N number of basic storage modules, wherein N is a natural number. Said every basic storage module includes one or multiple storage media. Storage volume can be increased through increasing the number of storage media.

Said storage media in said basic storage module is selected from but not limited to following storage media: Flash Memory, SDRAM, DRAM, EPPROM, Static Random Access Memory (SRAM), Ferroelectric Random Access Memory (FRAM), Magnetoresistive Random Access Memory (MRAM), super high density memory chip MILLIEPE, and etc.

Said control module 12 is connected to basic module(s) in said storage module 32 through a bus. Said bus includes control/status bus, address bus, data bus, in which the data bus is of 16-bit. Said 16-bit data bus is connected to basic storage modules through two 8-bit data bus; said basic storage module includes one or multiple 8-bit storage media.

As shown in FIG. 2, two 8-bit basic storage modules connecting to the same 16-bit data bus can be seen as one basic storage unit. In this preferred embodiment, the method of data access between said control module 12 and said storage module 32 for improving data transmission speed is comparable to the method of data access between the control module 10 and the storage module 30 in the first preferred embodiment, except that basic storage unit in this embodiment replaces the basic storage module in the first embodiment.

### 3. Embodiment Three

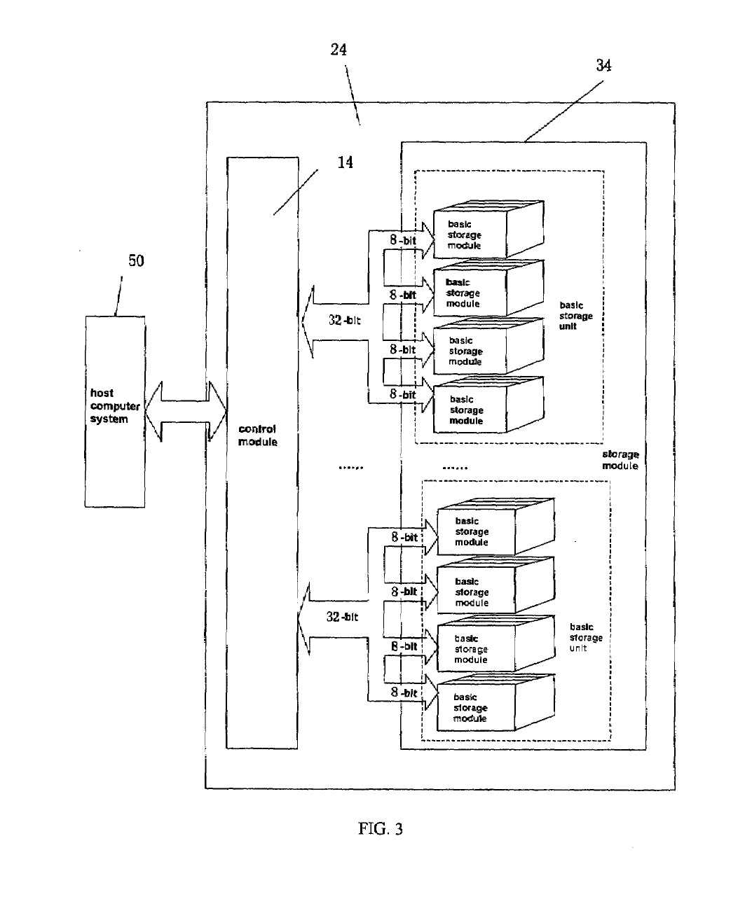

In the third embodiment (taking FIG. 3 in conjunction), a portable storage device 24 capable of improving data access speed includes a control module 14 and a storage module 34. Said control module 14 is connected to the host computer 50; said control module 14 can transmit data with the host computer 50 through various communication protocol; said communication protocol includes but not limited to USB Protocol, Zigbee Protocol, IEEE1394 Protocol, Blue Teeth Protocol, ATA Protocol, IDE Protocol, SCSI Protocol, HiperLAN Protocol, IrDA Infra Protocol, HomeRF Protocol, IEEE802.11x, IEEE802.11a, 802.11b, 802.11d, 802.11.g. 802.15, 802.16, 802.3 Protocol, RS232 Protocol, RS485 Protocol, USB_OTG Protocol, UWB Protocol, GPIO Protocol, UART Protocol, CF Protocol, SM Protocol, MMC Protocol, SD Protocol, MS Protocol, MD Protocol, X-D Protocol, PCMCIA Protocol, GSM, GPRS, CDMA, 2.5G and/or 3G Protocol, and etc.

Said storage module 34 includes N number of basic storage modules, wherein N is a natural number. Said every basic storage module includes one or multiple storage media. Increasing storage volume can be accomplished through increasing the number of storage media.

Said storage media in said basic storage module is selected from but not limited to following storage media: Flash Memory, SDRAM, DRAM, EPPROM, Static Random Access Memory (SRAM), Ferroelectric Random Access Memory (FRAM), Magnetoresistive Random Access Memory (MRAM), super high density memory chip MILLIEPE, and etc.

Said control module 14 is connected to basic module(s) in said storage module 34 through a bus. Said bus includes control/status bus, address bus, data bus, in which the data bus is of 32-bits. Said 32-bit data bus is connected to basic storage modules through four 8-bit data bus; said basic storage module includes one or multiple 8-bit storage media.

As shown in FIG. 3, four 8-bit basic storage modules connecting to the same 32-bit data bus can be seen as one basic storage unit. In this preferred embodiment, the method of data access between said control module 14 and said storage module 34 for improving data transmission speed is comparable to the method of data access between the control module 10 and the storage module 30 in the first preferred embodiment, except that basic storage unit in this embodiment replaces the basic storage module in the first embodiment.

### 4. Embodiment Four

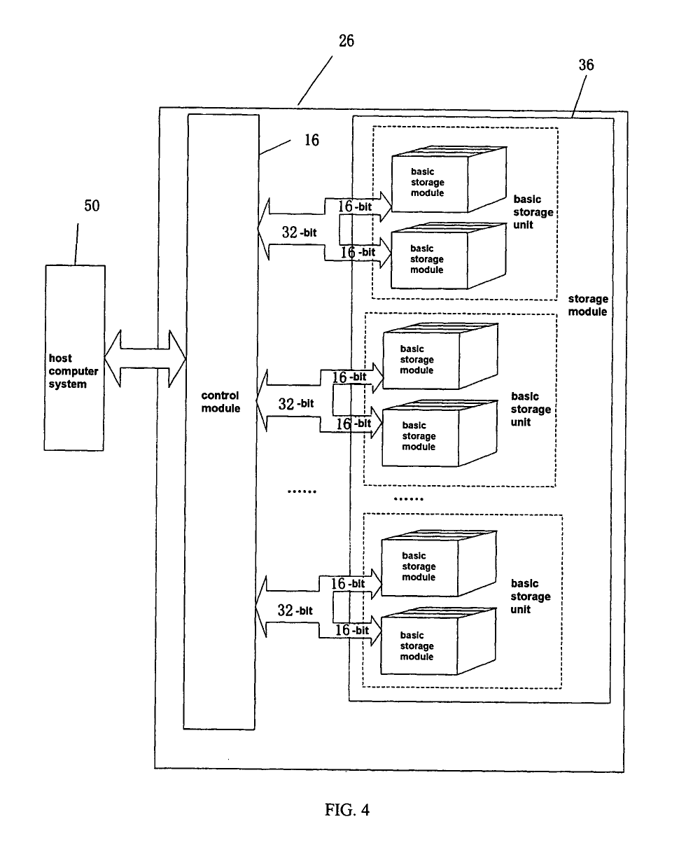

In the third embodiment (taking FIG. 4 in conjunction), a portable storage device capable of improving data transmission speed 26 includes a control module 16 and a storage module 36. Said control module 16 is connected to the host computer 50; said control module 16 can transmit data with the host computer 50 through various communication protocol; said communication protocol includes but not limited to USB Protocol, Zigbee Protocol, IEEE1394 Protocol, Blue Teeth Protocol, ATA Protocol, IDE Protocol, SCSI Protocol, HiperLAN Protocol, IrDA Infra Protocol, HomeRF Protocol, IEEE802.11x, IEEE802.11a, 802.11b, 802.11d, 802.11.g. 802.15, 802.16, 802.3 Protocol, RS232 Protocol, RS485 Protocol, USB_OTG Protocol, UWB Protocol, GPIO Protocol, UART Protocol, CF Protocol, SM Protocol, MMC Protocol, SD Protocol, MS Protocol, MD Protocol, X-D Protocol, PCMCIA Protocol, GSM, GPRS, CDMA, 2.5G and/or 3G Protocol, and etc.

Said storage module 36 includes N number of basic storage modules, wherein N is a natural number. Said every basic storage module includes one or multiple storage media. Storage volume can be increased through increasing the number of storage media.

Said storage media in said basic storage module is selected from but not limited to following storage media: Flash Memory, SDRAM, DRAM, EPPROM, Static Random Access Memory (SRAM), Ferroelectric Random Access Memory (FRAM), Magnetoresistive Random Access Memory (MRAM), super high density memory chip MILLIEPE, and etc.

Said control module 16 is connected to basic module(s) in said storage module 36 through a bus. Said bus includes control/status bus, address bus, data bus, in which the data bus is of 32-bit. Said 32-bit data bus is connected to basic storage modules through two 16-bit data bus; said basic storage module includes one or multiple 16-bit storage media.

As shown in FIG. 4, two 16-bit basic storage modules connecting to the same 32-bit data bus can be seen as one basic storage unit. In this preferred embodiment, the method of data access between said control module 16 and said storage module 36 to improve data transmission speed is comparable to the method of data access between the control module 10 and the storage module 30 in the first preferred embodiment, except that basic storage unit in this embodiment replaces the basic storage module in the first embodiment.

The above described preferred embodiments should not be construed to limit the scope of the claims. Technical feature(s) not described in the embodiments but understood to be within the scope of the claims by the ordinary skilled artisans is (are) also sought to be covered by this application.

1. A portable storage device for improving data access speed, wherein said device is capable of data transmission with a host computer; said device comprising:
a control module capable of data transmission with a host computer through a communication protocol;
a data storage module comprising one or more basic storage modules, wherein said control module can perform data access operation on said basic storage module(s).

2. The portable storage device for improving data access speed according to claim 1, wherein said basic storage module comprises one storage media or multiple storage media.

3. The portable storage device for improving data access speed according to claim 1, wherein said communication protocol is USB Protocol, Zigbee Protocol, IEEE1394 Protocol, Blue Tooth Protocol, Serial ATA Protocol, IDE Protocol, SCSI Protocol, HiperLAN Protocol, IrDA Infra protocol, HomeRF Protocol, IEEE802.11x, IEEE802.11a, 802.11b, 802.11d, 802.11g, 802.15, 802.16, 802.3 Protocol, RS232 Protocol, RS485 Protocol USB_OTG Protocol, UWB Protocol, GPIO Protocol, UART Protocol, CF Protocol, SM Protocol, MMC Protocol, SD Protocol, MS Protocol, MD Protocol, X-D Protocol, PCMCIA Protocol, GSM, GPRS, CDMA, 2.5G Protocol or 3G

4. The portable storage device for improving data access speed according to claim 1, wherein said control module is connected to said basic storage module through control bus, address bus, and data bus, wherein said data bus is selected from 8-bit, 16-bit and 32-bit data bus.

5. The portable storage device for improving data access speed according to claim 1, wherein said control module is connected to said basic storage module through control bus, address bus, and data bus, wherein when said data bus is of 16-bit, it can connect to the basic storage module through two 8-bit data buses respectively.

6. The portable storage device for improving data access speed according to claim 1, wherein said control module is connected to said basic storage module through control bus, address bus, and data bus, wherein when said data bus is of 32 bit, it can connect to the basic storage module through four 8-bit data buses respectively.

7. The portable storage device for improving data access speed according to claim 1, wherein said control module is connected to said basic storage module through control bus, address bus, or data bus, wherein when said data bus is of 32 bit, it can connect to the basic storage module through two 16-bit data buses respectively.

8. The portable storage device for improving data access speed according to claim 1, wherein said basic storage module utilizes storage media which is selected from the following: Flash Memory, SDRAM, DRAM, EPPROM, Static Random Access Memory (SRAM), Ferroelectric Random Access Memory (FRAM), Magnetoresistive Random Access Memory (MRAM), and super high density memory chip MILLIEPE.

9. A method for improving data access speed applicable to the improvement of data access speed between a host computer and a portable storage device, said portable storage device includes a control module capable of data transmission with a host computer through a communication protocol, and a storage module for data storage; said method comprising:
1) providing one or multiple basic storage module for data storage in said storage module;
2) providing one or multiple data channels between said control module and corresponding said basic storage and
3) performing data reading and writing operation on the data from the host computer using data packet as unit, in a time slicing manner through said corresponding data channel.

10. The method for improving data access speed according to claim 9, wherein said data packet's size is 512 bytes, 528 bytes, 2048 bytes or 2112 bytes.

11. The method for improving data access speed according to claim 9, wherein said data channel(s) are connected to said control module and said basic storage module is a data bus of 8-bit, 16-bit or 32-bit.

12. The method for improving data access speed according to claim 9, wherein said data channel is a 16-bit data bus connecting to two 8-bit data buses which are then connected to said basic storage modules respectively.

13. The method for improving data access speed according to claim 9, wherein said data channel is a 32-bit data bus connecting to two 16-bit data buses which are then connected to said basic storage modules respectively.

14. The method for improving data access speed according to claim 9, wherein said data channel is a 32-bit data bus connecting to four 8-bit data buses which are then connected to said basic storage modules respectively.

15. The method for improving data access speed according to claim 9, wherein said communication protocol is USB Protocol, Zigbee Protocol, IEEE1394 Protocol, Blue Tooth Protocol, Serial ATA Protocol, IDE Protocol, SCSI Protocol, HiperLAN Protocol, IrDA Infra protocol, HomeRF Protocol, IEEE802.11x, IEEE802.11a, 802.11b, 802.11d, 802.11g, 802.15, 802.16, 802.3 Protocol, RS232 Protocol, RS485 Protocol, USB_OTG Protocol, UWB Protocol, GPIO Protocol, UART Protocol, CF Protocol, SM Protocol, MMC Protocol, SD Protocol, MS Protocol, MD Protocol, X-D Protocol, PCMCIA Protocol, GSM, GPRS, CDMA, 2.5G Protocol, or 3G Protocol.

16. The method for improving data access speed according to claim 9, wherein said basic storage module comprises one storage media or multiple storage media.

17. The method for improving data access speed according to claim 9, wherein said basic storage module utilizes storage media selected from the following: Flash Memory, SDRAM, DRAM, EPPROM, Static Random Access Memory (SRAM), Ferroelectric Random Access Memory (FRAM), Magnetoresistive Random Access Memory (MRAM), and super high density memory chip MILLIEPE.

18. A method for improving data access speed applicable to the improvement of data access speed between a host computer and a portable storage device, said portable storage device includes a control module capable of data transmission with a host computer through a communication protocol, and a storage module for data storage; said method comprising:
1) providing one or multiple basic storage module for data storage in said storage module;
2) providing one or multiple data channels between said control module and corresponding said basic storage module(s);
3) performing data reading and writing operation on the data from the host computer using data packet as unit, wherein the data packet is divided into several portions which are sent to the multiple basic storage modules being operated through said data channels simultaneously.

19. The method for improving data access speed according to claim 18, wherein said data packet's size is 512 bytes, 528 bytes, 2048 bytes or 2112 bytes.

20. The method for improving data access speed according to claim 18, wherein said data channel(s) are connected to said control module and said basic storage module is a data bus of 8-bit, 16-bit, or 32-bit.

21. The method for improving data access speed according to claim 18, wherein said data channel is a 16-bit data bus connected to two 8-bit data buses which are then connected to said basic storage modules respectively, or a 32-bit data bus connected to two 16-bit data buses which are then connected to said basic storage modules respectively, or a 32-bit data bus connected to four 8-bit data buses which are then connected to said basic storage modules respectively.

22. The method for improving data access speed according to claim 18, wherein said communication protocol is USB Protocol, Zigbee Protocol, IEEE1394 Protocol, Blue Tooth Protocol, Serial ATA Protocol, IDE Protocol, SCSI Protocol, HiperLAN Protocol, IrDA Infra protocol, HomeRF Protocol, IEEE802.11x, IEEE802.11a, 802.11b, 802.11d, 802.11g, 802.15, 802.16, 802.3 Protocol, RS232 Protocol, RS485 Protocol, USB_OTG Protocol, UWB Protocol, GPIO Protocol, UART Protocol, CF Protocol, SM Protocol, MMC Protocol, SD Protocol, MS Protocol, MD Protocol, X-D Protocol, PCMCIA Protocol, GSM, GPRS, CDMA, 2.5G Protocol, or 3G Protocol.

23. The method for improving data access speed according to claim 18, wherein said basic storage module utilizes storage media selected from the following: Flash Memory, SDRAM, DRAM, EPPROM, Static Random Access Memory (SRAM), Ferroelectric Random Access Memory (FRAM), Magnetoresistive Random Access Memory (MRAM), and super high density memory chip MILLIEPE.

24. The method for improving data access speed according to claim 18, wherein said basic storage module comprises one storage media or multiple storage media.
